(19) United States
(12) Patent Application Publication
(10) Pub. No.: US 2026/0201852 A1
(43) Pub. Date: Jul. 16, 2026

(54) TRIPLE-FLOW AIRCRAFT TURBINE ENGINE

(71) Applicants: SAFRAN AIRCRAFT ENGINES, Paris (FR); GENERAL ELECTRIC COMPANY, Schenectady, NY (US)

(72) Inventors: Raul MARTINEZ LUQUE, MOISSY-CRAMAYEL (FR); Damien Bernard Emeric GUEGAN, MOISSY-CRAMAYEL (FR); Antoine Claude Baudoin Raoul Marie SECONDAT DE MONTESQUIEU, MOISSY-CRAMAYEL (FR); Laurent SOULAT, MOISSY-CRAMAYEL (FR); Mickaël Franck Antoine SCHVALLINGER, MOISSY-CRAMAYEL (FR)

(73) Assignees: SAFRAN AIRCRAFT ENGINES, Paris (FR); GENERAL ELECTRIC COMPANY, Schenectady, NY (US)

(21) Appl. No.: 19/135,606

(22) PCT Filed: Dec. 5, 2022
(86) PCT No.: PCT/FR2022/052253

§ 371 Date: Jun. 4, 2025

(51) Int. Cl. F02K 3/077; F01D 9/04; F01D 17/16

(52) U.S. Cl. CPC F02K 3/077; F01D 9/041; F01D 17/162; F05D 2220/323; F05D 2240/12

(57) ABSTRACT

A triple-flow aircraft turbine engine, having two coaxial annular walls, rotor blading an annular separator arranged downstream of the rotor blading and between the two walls, and having, upstream, an annular nose, stationary guide vanes connected to the nose, and variable-pitch guide vanes downstream of the stationary guide vanes.

### TECHNICAL FIELD OF THE INVENTION

The present invention relates to the general field of the aeronautic. More specifically, it is aimed at a triple-flow aircraft turbine engine.

### TECHNICAL BACKGROUND

Conventionally, an aircraft turbine engine comprises a gas generator comprising along a longitudinal axis at least one compressor, a combustion chamber, and at least one turbine. An air flow enters the gas generator and is compressed in the compressor or the compressors. This compressed air flow is mixed with fuel and burned in the combustion chamber and the combustion gases are expanded in the turbine or the turbines. This expansion causes the turbine rotor or rotors to rotate, which drives the compressor rotor or rotors to rotate. The combustion gases are ejected through a nozzle to provide a thrust which may be in addition to a thrust provided by at least one propulsion ducted or non-ducted propeller or fan of the turbine engine.

The gas flows flow in the turbine engine through annular ducts. As may be seen in FIG. 1a, the turbine engine 10 thus comprises coaxial annular walls, respectively internal 12 and external 14, extending around each other and defining between them a main annular flow duct 16 for a main gas flow 18.

In the case where the main gas flow 18 is to be divided into two secondary gas flows, respectively internal 20 and external 22, an annular separator 24 is arranged between the two walls 12, 14 and defines respectively with these walls 12, 14 two secondary annular flow ducts, respectively internal 26 and external 28, for the secondary gas flows 20, 22. This separator 24 comprises at an upstream end an annular nose 24a configured to split the main gas flow 18 into two and form the secondary gas flows 20, 22.

A rotor blading 30 may extend radially across the main duct 16, thus upstream of the separator 24.

As illustrated in FIG. 1a, structural arms 32 may extend radially across the main duct 16 downstream of the rotor blading 30 and upstream of the separator 24.

As used in this application, arm 32 or structural arm means a stator element that has a general aerodynamic cross-sectional shape such as that shown in FIG. 1b, but does not comprise pressure side or suction side. An arm 32 is not comparable to a vane or blade which is profiled so as to comprise a pressure side and a suction side. An arm 32 is generally symmetrical with respect to a plane P passing through the axle of the turbine engine. The number of arms 32 is usually less than 10 and may be 4. At least one of the arms 32 may be hollow and tubular in the radial direction to be passed through by auxiliaries and be used for the passage of these auxiliaries through the ducts in the engine.

For certain types of turbine engine, such as multi-flow or variable cycle turbine engines, it would be useful to have a stator blading 34 directly downstream of the rotor blading 30 and integrated into the flow splitter nose 24a instead of being positioned between the rotor 30 and the separator 24 (see FIG. 2a), so as to reduce the length of the module between the concept illustrated in FIG. 1a and that illustrated in FIG. 2a. The stator blading 34 would comprise a plurality of vanes distributed around the axle of the turbine engine. As mentioned above and illustrated in FIG. 2b, each of these vanes would have an aerodynamic profile in cross-section comprising a pressure side 34a and a suction side 34b (FIG. 2b), i.e. a non-symmetrical profile, which is not the case for the arm 32 visible in FIG. 1a. The stator blading 34 would extend radially across the main duct 16. In the event that the nose 24a would be connected to the vanes of the stator blading 34, these vanes would comprise leading edges 36 located upstream of the nose 24a, in the main duct 16, and trailing edges, respectively internal 38a and external 38b, located in the internal 26 and external 28 ducts. The stator blading 34 would impose a particular direction on the gas flows 16, 20, 22. However, in the case of a variable cycle turbine engine, it would be useful to provide variable geometry downstream of the stator blading 34 to accommodate different operating regimes and variations in the bypass ratio of the turbine engine. However, for overall dimension reasons, the adding of a variable pitch blading downstream of the stator blading 34 may be complex. Indeed, this addition would require lengthening the axial dimension of the turbine engine, which would result in an increase in the mass of the turbine engine and a reduction in its performance.

Moreover, for reasons of noise, it would not be possible to move the stator blading 34 axially closer towards the rotor blading 30.

In the present application, a variable-cycle turbine engine means a turbine engine whose specific thrust may be changed at a given engine speed, by controlling variable geometries of the turbine engine. An example of variable geometry is a variable pitch stator blading. In the present application, blading is defined as an annular row of vanes.

The invention thus proposes to optimize a turbine engine as illustrated in FIG. 2a so that it may be used in several configurations and in particular in the context of a multi-flow turbine engine (at least two) and/or a variable cycle turbine engine.

### SUMMARY OF THE INVENTION

The present invention proposes a triple-flow aircraft turbine engine, comprising a gas generator comprising along a longitudinal axis at least one compressor, a combustion chamber and at least one turbine, the turbine engine further comprising:
two coaxial annular walls, respectively internal and external, extending around each other and defining between them a main annular duct for a main air flow,
a rotor blading extending radially across said main duct and forming a ducted propeller,
an annular separator arranged downstream of the rotor blading and between the two walls, the separator defining with the internal and external walls respectively two secondary flow annular ducts, respectively internal and external, for the secondary air flow, respectively internal and external, the separator comprising at an upstream end an annular nose configured to split the main air flow into two and to form the secondary air flows,
stator elements extending radially on the one hand through said main duct and on the other hand through said secondary ducts, these stator elements being connected to said annular nose,
   and
a non-ducted propeller disposed upstream of the external wall, characterized in that said stator elements comprise:
stationary guide vanes which are distributed around said axis and which each comprise a leading edge located upstream of said nose, and trailing edges, respectively internal and external, located respectively in the internal and external secondary ducts, these stationary guide vanes being connected to said nose, and
variable pitch guide vanes distributed about said axis and which extend radially through at least one of said secondary ducts, each of the variable pitch guide vanes comprising a leading edge and a trailing edge,
   and in that:
the leading edges of the variable-pitch guide vanes are located upstream of the internal and/or external trailing edges of the stationary guide vanes,
   or
the leading edges of the variable pitch guide vanes are located directly downstream of the internal and/or external trailing edges of the stationary guide vanes, and are separated by predetermined axial clearances from these trailing edges.

The present invention thus proposes to use both stationary guide vanes and variable pitch guide vanes in place of the arms in FIG. 1a or the stator blading in FIG. 1b. The stationary and variable pitch guide vanes are axially closely spaced or axially interlocked so that they may be considered as an assembly forming the stator elements within the meaning of the invention. In fact, either the variable pitch guide vanes have their leading edges located upstream of the trailing edges of the stationary guide vanes, or the variable pitch guide vanes are separated by predetermined axial clearances, preferably as small as possible, from the trailing edges of the stationary guide vanes. By minimizing these axial clearances, the passage of gas during operation between the trailing edges of the stationary guide vanes and the leading edges of the variable pitch guide vanes is limited or prevented. It is thus understood that the gases flowing over the pressure side of the stationary guide vanes must then flow over the pressure side of the variable pitch guide vanes, and that the gases flowing over the suction side of the stationary guide vanes must then flow over the suction side of the variable pitch guide vanes.

This configuration is particularly advantageous as it allows to optimize the operation of the turbine engine, allowing for multi-flow or variable cycle applications, while limiting the impact on the length or axial dimension and the mass of the turbine engine. Indeed, reducing the axial clearance between the guide vanes and positioning them at the level of the nose allows to limit the impact of these vanes on the axial dimension of the turbine engine.

Upstream of the rotor blading located in the first duct, there may be any configuration for the turbine engine.

In the present application, “annular” means a shape of revolution around an axis, which may be continuous or interrupted. Furthermore, in the present application, a “variable pitch” element is defined as an element one portion of which has a position that may be adjusted about an axis, which is referred to as the pitch axis. The entirety of this element or only one portion of this element may be with variable pitch. In the case of a vane for example, it may be one-part and have an adjustable position around a pitch axis. Alternatively, it may comprise only one portion, comprising for example a leading edge or a trailing edge, the position of which would be adjustable around a pitch axis in relation to the rest of the vane. In the case of a blading comprising several vanes, each of the vanes has an adjustable position around its own pitch axis. For the same blading, there are as many pitch axes as there are variable pitch vanes. Each of these axes may have a radial or inclined orientation with respect to the longitudinal axis of the turbine engine.

The turbine engine may comprise one or more of the following characteristics, taken alone or in combination with one another:
said clearances are less than 10 mm, and preferably less than or equal to 5 mm;
said clearances are less than 10% of the chord of one of the stationary or variable pitch vanes, and preferably less than or equal to 5% of that chord;
said stationary guide vanes comprise a pressure side and a suction side, and said variable pitch guide vanes comprise a pressure side and a suction side;
the number of said variable pitch guide vanes is greater than or equal to the number of said stationary guide vanes;
said variable pitch guide vanes are located in said internal secondary duct;
the trailing edges of said variable pitch guide vanes are located downstream of the external trailing edges of the stationary guide vanes;
the turbine engine further comprises a system for controlling the angular pitch of the variable pitch guide vanes, this system being mounted in said separator;
the turbine engine further comprises a system for controlling the angular pitch of the variable pitch guide vanes, this system being mounted radially outwardly of said external wall;
said variable pitch guide vanes are located in said external secondary duct;
first variable pitch guide vanes are located in said internal secondary duct, and second variable pitch guide vanes are located in said external secondary duct;
the turbine engine further comprises a common system for controlling the angular pitch of the first and second variable pitch guide vanes, or independent systems for controlling the angular pitch of the first and second variable pitch guide vanes respectively;
the turbine engine further comprises structural arms distributed around said axis in said external secondary duct;
the number of structural arms is less than the number of stationary guide vanes;
the structural arms are connected to some of said stationary guide vanes;
the rotor blading is a fan or a compressor rotor blading;
the leading edges of the variable pitch guide vanes are located at a distance from the internal and/or external trailing edges of the stationary guide vanes, which is greater than 10% of the chord of one of these vanes, and more preferably greater than or equal to 20% of this chord;
at least some of the stationary guide vanes have different profiles or curvatures to the other stationary guide vanes;
at least some of the arms have different profiles to the other arms.

The present invention also relates to an aircraft, in particular a transport plane, comprising a turbine engine as described above.

### BRIEF DESCRIPTION OF THE FIGURES

Further characteristics and advantages of the invention will become apparent from the following detailed description, for the understanding of which reference is made to the appended drawings wherein:

FIG. 1a is a very schematic half-view in axial cross-section of an aircraft turbine engine, according to the technique prior to the invention;

FIG. 1b is a very schematic cross-sectional view of an arm of the turbine engine of FIG. 1a;

FIG. 2a is a very schematic axial sectional half-view of a portion of an aircraft turbine engine;

FIG. 2b is a very schematic cross-sectional view of a stator vane of the turbine engine of FIG. 2a;

FIG. 3a is a very schematic half-view in axial cross-section of an aircraft turbine engine, according to a first embodiment of the invention;

FIG. 3b is a very schematic cross-sectional view of two stationary guide vanes followed by two variable-pitch guide vanes of the turbine engine of FIG. 3a, and illustrates, on the left and right of the figure respectively, two distinct positions wherein the variable-pitch guide vanes are set;

FIG. 4a is a very schematic half-view in axial cross-section of an aircraft turbine engine, according to a second embodiment of the invention;

FIG. 4b is a highly schematic cross-sectional view of two stationary guide vanes followed by three variable pitch guide vanes of the turbine engine of FIG. 4a, and illustrates, on the left and right of the figure respectively, two distinct pitch positions of the variable pitch guide vanes;

FIG. 5a is a very schematic half-view in axial cross-section of an aircraft turbine engine, according to a third embodiment of the invention;

FIG. 5b is a very schematic cross-sectional view of two stationary guide vanes interposed with two variable pitch guide vanes of the turbine engine of FIG. 5a, and illustrates, on the left and right of the figure respectively, two distinct pitch positions of the variable pitch guide vanes;

FIG. 6 is a very schematic half-view in axial cross-section of an aircraft turbine engine, according to a fourth embodiment of the invention;

FIG. 7 is a very schematic half-view in axial cross-section of an aircraft turbine engine, according to a fifth embodiment of the invention;

FIG. 8 is a very schematic half-view in axial cross-section of an aircraft turbine engine, according to a sixth embodiment of the invention;

FIG. 9 is a very schematic half-view in axial cross-section of an aircraft turbine engine, according to a seventh embodiment of the invention;

FIG. 10 is a highly schematic half-view of an aircraft turbine engine in axial cross-section, according to an eighth embodiment of the invention;

FIG. 11 is a very schematic half-view of an aircraft turbine engine in axial cross-section, according to a ninth embodiment of the invention;

FIG. 12 is a very schematic half-view of an aircraft turbine engine in axial cross-section, according to a tenth embodiment of the invention;

FIG. 13 is a highly schematic half-view of an aircraft turbine engine in axial cross-section, according to an eleventh embodiment of the invention; and

FIG. 14 is a schematic view of a triple-flow turbine engine within the scope of the present invention.

### DETAILED DESCRIPTION OF THE INVENTION

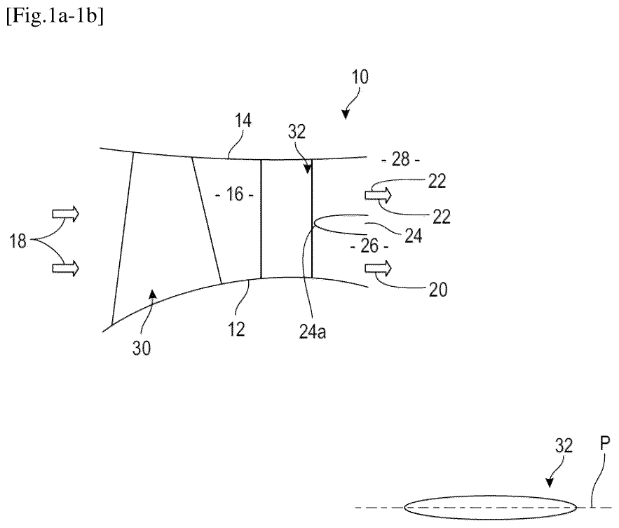

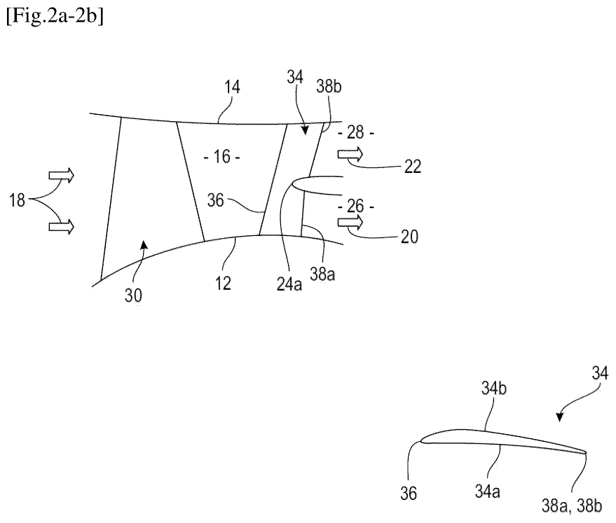

FIGS. 1a, 1b, 2a and 2b have been described in the above.

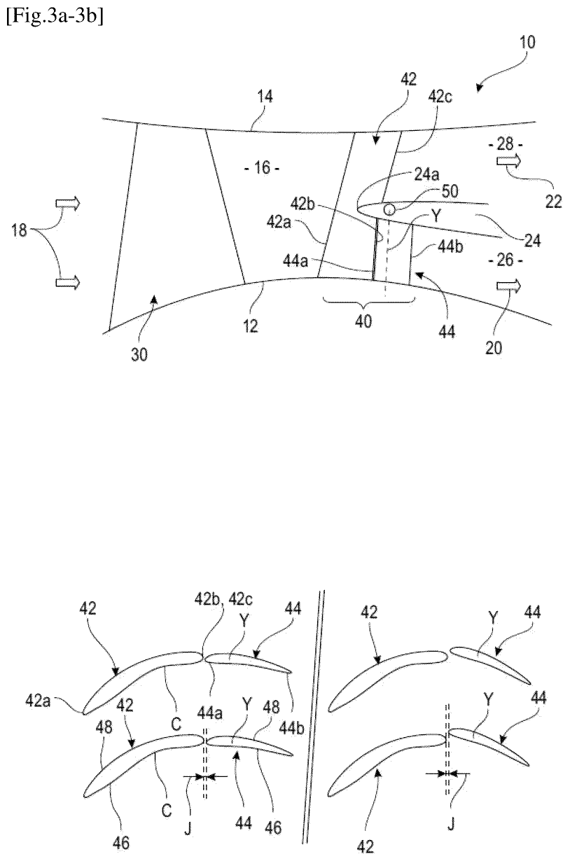

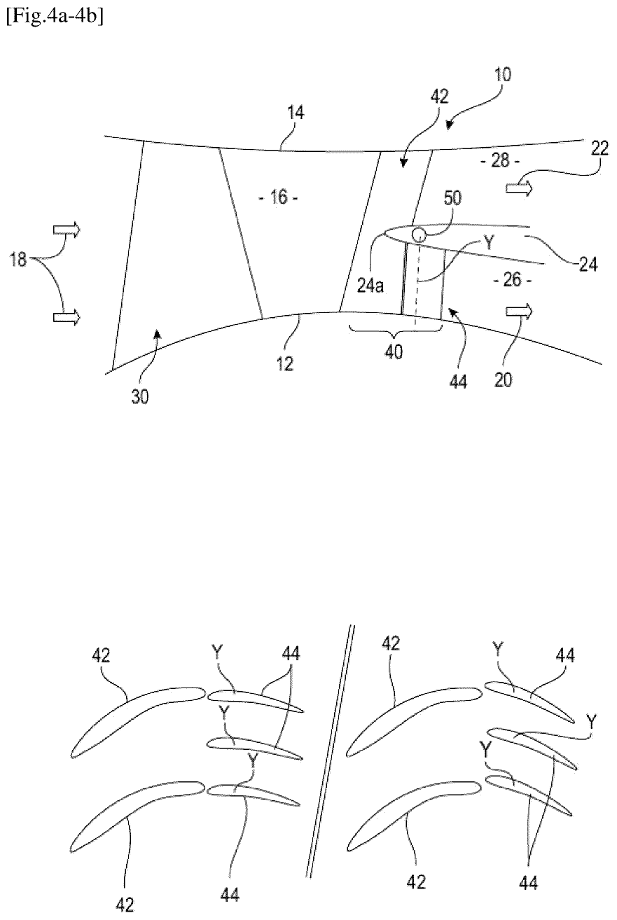

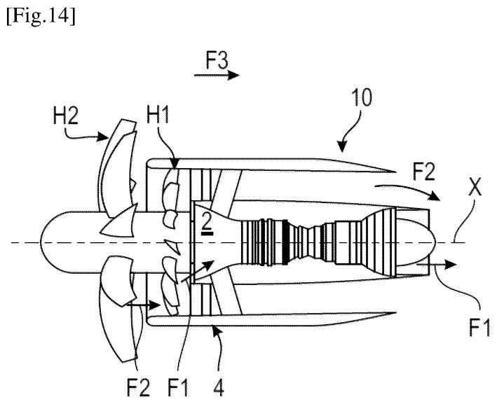

With reference to FIG. 14, the turbine engine 10 is of the triple-flow type and conventionally comprises a gas generator 2 comprising along a longitudinal axis X at least one compressor, a combustion chamber and at least one turbine. The turbine engine also comprises a ducted propeller or fan noted H1 and a non-ducted propeller or fan noted H2. The propeller H1 is surrounded by a nacelle 4 which extends around the axis X downstream of the propeller H2. The air flow which pass through the propeller H2 is separated by the nacelle 4 into a main flow F2 that enters the nacelle 4 and another flow F3 that flows around the nacelle 4. The main flow F2 is then divided into two further flows F1, F2 as explained in the following. In the scope of the present invention illustrated in FIGS. 3a and 3b, the turbine engine 10 comprises two coaxial annular walls, internal 12 and external 14 respectively, extending around each other and defining between them a main annular flow duct 16 for a main gas flow 18.

The main gas flow 18 is divided into two secondary gas flows, respectively internal 20 and external 22, by an annular separator 24 which is arranged between the two walls 12, 14. This separator 24 comprises at an upstream end an annular nose 24a configured to split the main gas flow 18 into two and form the secondary gas flows 20, 22.

A rotor blading 30 extends radially across the main duct 16, upstream of the separator 24. In the scope of the turbine engine of FIG. 14, this rotor blading 30 forms the ducted propeller H1.

Stator elements 40 are located downstream of the rotor blading 30 and at the level of the splitter nose 24a.

According to the invention, these stator elements 40 comprise stationary guide vanes 42 and variable pitch guide vanes 44.

The stationary vanes 42 are distributed around the axis and each comprise a leading edge 42a located upstream of the nose 24a, and trailing edges, respectively internal 42b and external 42c, located respectively in the internal 26 and external 28 secondary ducts. It is thus understood that the stationary vanes 42 are connected to the nose 24a, as may be seen in the drawing. As is also visible, the leading edges 42a may be inclined and extend outwardly from upstream to downstream. This inclination is for example determined according to a compromise between the size of the engine and the optimization of the noise it generates. To minimize the noise, it is best to increase the height at the top of the blade, which results in a higher inclination of the blade.

FIG. 3b shows that each of the stationary vanes 42 has an aerodynamic profile and comprises a pressure side 46 (concave curved shape) and a suction side 48 (convex curved shape). In addition, each of the stationary vanes 42 has a certain curvature along its chord. C is the area of greatest curvature of a stationary vane 42. This area is preferably located upstream of the nose 24a.

The stationary vanes 42 are preferably all identical. Their leading edges 42a are preferably passed through by the same transverse plane. The number of stationary vanes 42 is for example between 10 and 200. The variable pitch vanes 44 are distributed around the axis in the internal secondary duct 26 only.

The variable pitch vanes 44 each comprise a leading edge 44a located downstream of the nose 24a, and a trailing edge 44b located in the internal secondary duct 26.

FIG. 3b shows that each of the variable pitch vanes 44 has an aerodynamic profile and comprises a pressure side 46 (concave curved shape) and a suction side 48 (convex curved shape). In addition, each of the variable pitch vanes 44 has some curvature along its chord. In this embodiment, the number of variable pitch vanes 44 is equal to the number of stationary vanes 42 and the variable pitch vanes 44 are located directly downstream of the stationary vanes 42 and in axial extension of them. The leading edges 44a of the variable pitch vanes 44 are separated by predetermined axial clearances J from the trailing edges 42b of the stationary vanes 42. Preferably, these clearances J are less than 10 mm and more preferably less than or equal to 5 mm. Preferably, these clearances J are less than 10% of the chord of a vane 42 or a vane 44, and more preferably less than or equal to 5% of this chord. Each of these clearances J is preferably constant over the entire radial extent of the edges 42b, 44a concerned and thus of the internal duct 26. Naturally, these clearances J are likely to vary during operation depending on the pitch positions of the vanes 44 in relation to the vanes 42.

The variable pitch vanes 44 are preferably all identical. Their leading edges 44a are preferably in a same transverse plane or passed through by a same transverse plane.

The number of variable pitch vanes 44 is for example between 10 and 200. Each of the variable pitch vanes 44 is rotatable about a pitch axis Y which has a substantially radial orientation. The rotation of each of the variable pitch vanes 44 is achieved by a control system 50 which is located in the separator 24.

FIG. 3b shows a first angular or pitch position of the variable pitch vanes 44 on the left and a second angular or pitch position of these vanes on the right. The variable pitch vanes 44 may, for example, be displaced through angular ranges of the order of 60°about their axes Y.

FIGS. 4a and 4b illustrate a second embodiment of the invention which differs from the previous embodiment essentially in that the number of variable pitch vanes 44 is different from the number of stationary vanes 42 and is here greater than the number of stationary vanes 42. In this embodiment, there are twice as many variable pitch vanes 44 as stationary vanes 42. It is therefore understood that the circumferential pitch between the stationary vanes 42 is twice as large as the circumferential pitch between the variable pitch vanes 44. Alternatively, the number of stationary vanes 42 is equal to a multiple of the number of variable pitch vanes 44, which is different from 2 and which is for example 3, 4, etc.

One half of the variable pitch vanes 44 extends downstream and axially in line with the stationary vanes 42, as in the embodiment of FIGS. 3a and 3b. The other half of the variable pitch vanes 44 are interposed between the stationary vanes 42 and therefore do not extend into the extension of the stationary vanes 42.

The variable pitch vanes 44 are preferably all identical. Their leading edges 44a are preferably located in a same transverse plane or passed through by a same transverse plane, as in the case of the stationary vanes 42.

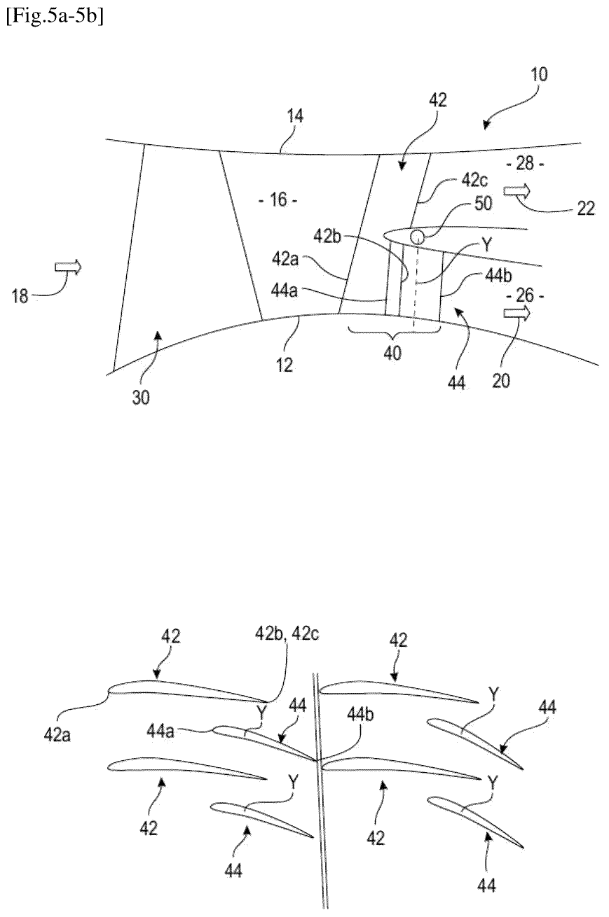

FIGS. 5a and 5b illustrate a third embodiment of the invention which differs from the first embodiment essentially in the positioning of the variable pitch vanes 44 relative to the stationary vanes 42.

The variable pitch vanes 44 are axially interposed between the stationary vanes 42 and are arranged between these vanes 42. The variable pitch vanes 44 are not located in the axial extension of the stationary vanes 42 but are instead angularly offset by half a pitch in relation to the axle of the turbine engine and are therefore each located halfway between two stationary vanes 42. The leading edges 44a of the variable pitch vanes 44 are located upstream of the trailing edges 42b of the stationary vanes 42. The trailing edges 44b of the variable pitch vanes 44 are located downstream of the trailing edges 42b of the stationary vanes.

The interlocking distance of the variable pitch vanes 44 between the stationary vanes 42 is noted as W and may be estimated as a percentage chord of one of the vanes 42 or one of the vanes 44. Preferably, this distance W is greater than 10% of the chord of a vane 42 or a vane 44, and more preferably greater than or equal to 20% of this chord.

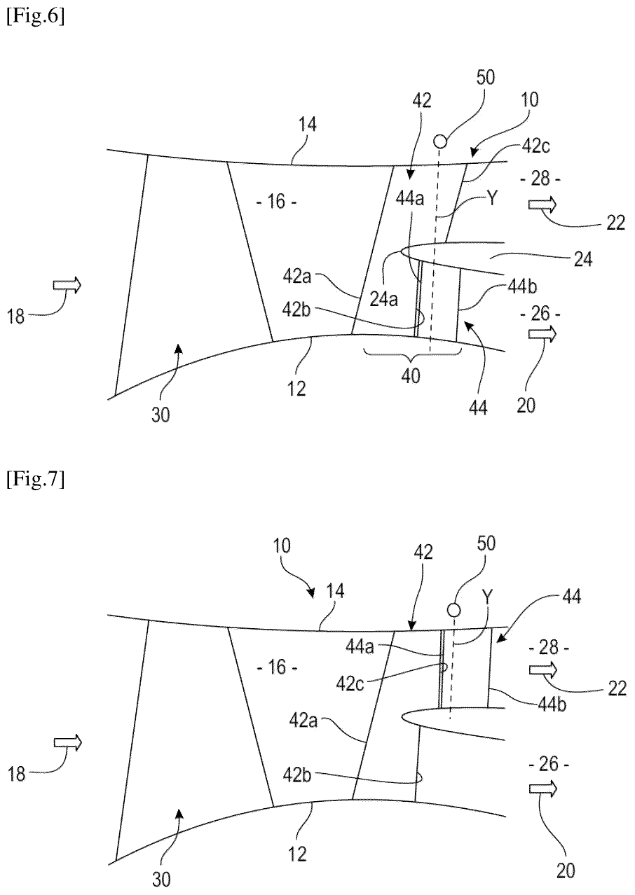

FIG. 6 illustrates a fourth embodiment of the invention which differs from the first embodiment essentially in that the control system 50 is here located radially outside the external wall 14. This is advantageous because it allows this system to be located in a relatively cool environment compared to the high temperatures that may occur in the gas generator. Moreover, this environment is not very constrained and contains free spaces to accommodate this type of system.

This system 50 is connected to the variable pitch vanes 44 and passes through the stationary vanes 42. These vanes 42 may thus be extended in the axial direction and comprise an internal passage extending in the radial direction through the external duct 28 to allow the system 50 to be mounted and connected to the variable pitch vanes 44. It is therefore understood that the trailing edges 42c of the stationary vanes 42 may be located downstream of the trailing edges 42b of these vanes.

FIG. 7 illustrates a fifth embodiment of the invention which differs from the first embodiment in the position of the variable pitch vanes 44. The variable pitch vanes 44 are distributed around the axis in the external secondary duct 28 only.

The variable pitch vanes 44 each comprise a leading edge 44a located downstream of the nose 24a, and a trailing edge 44b located in the external secondary duct 28.

Each of the variable pitch vanes 44 has an aerodynamic profile and comprises a pressure side and a suction side. In addition, each of the variable pitch vanes 44 has some curvature along its chord. The number of variable pitch vanes 44 may be equal to or greater than the number of stationary vanes 42, as discussed above in relation to FIGS. 3a to 4b.

The variable pitch vanes 44 are located directly downstream of the stationary vanes 42 and in axial extension of them. The leading edges 44a of the variable pitch vanes 44 are separated by predetermined axial clearances J from the trailing edges 42c of the stationary vanes 42. Preferably, these clearances J are less than 10 mm and more preferably less than or equal to 5 mm. Preferably, these clearances J are less than 10% of the chord of a vane 42 or a vane 44, and more preferably less than or equal to 5% of this chord. Each of these clearances J is preferably constant over the entire radial extent of the relevant edges 42c, 44a and thus of the external duct 28. Naturally, these clearances J are likely to vary during operation depending on the pitch positions of the vanes 44 in relation to the vanes 42.

The variable pitch vanes 44 are preferably all identical. Their leading edges 44a are preferably located in a same transverse plane or passed through by a same transverse plane.

The number of variable pitch vanes 44 is for example between 10 and 200.

Each of the variable pitch vanes 44 is rotatable about a pitch axis Y which has a substantially radial orientation. The rotation of each of the variable pitch vanes 44 is achieved by means of a control system 50 which is located here radially outside the external wall 14.

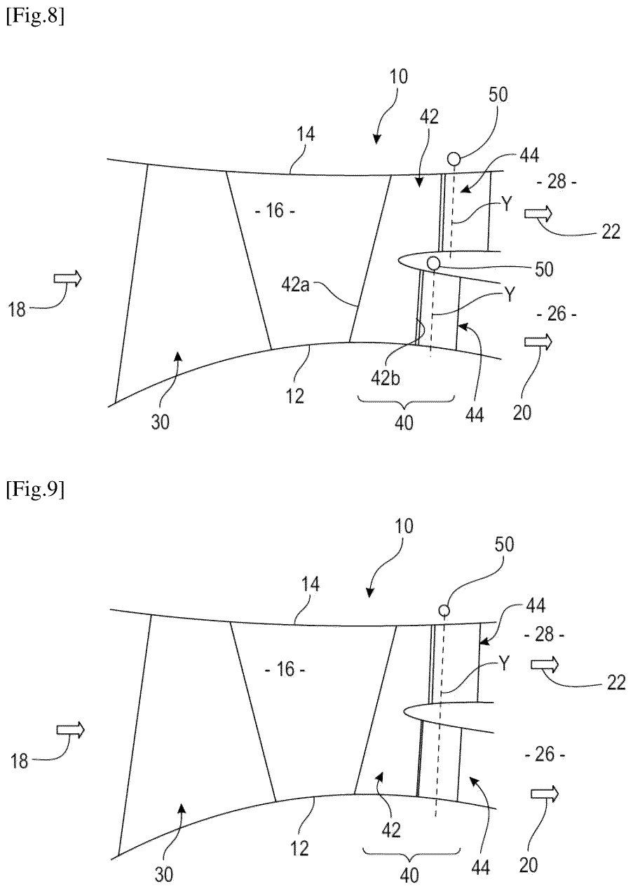

FIG. 8 illustrates a sixth embodiment of the invention which differs from the first embodiment in that variable pitch vanes 44 are additionally distributed around the axis in the external secondary duct 28. The variable pitch vanes 44 of the internal duct 26 may be similar to those described above in relation to FIGS. 3a and 3b, or 4a and 4b, and the variable pitch vanes 44 of the external duct 28 may be similar to those described above in relation to FIGS. 7a and 7b.

The angular pitch of the variable pitch vanes 44 located in the two ducts is controlled by independent systems 50. A first control system 50 is located in the separator 24 and controls the pitch of the variable pitch vanes 44 in the internal duct 26, and a second control system 50 is located radially outside the wall 14 and controls the pitch of the variable pitch vanes 44 in the external duct 28. In the seventh embodiment shown in FIG. 9, a single control system 50 is used to control the angular pitch of the variable pitch vanes 44 located in the two ducts 26, 28. This control system 50 is located radially outside the wall 14.

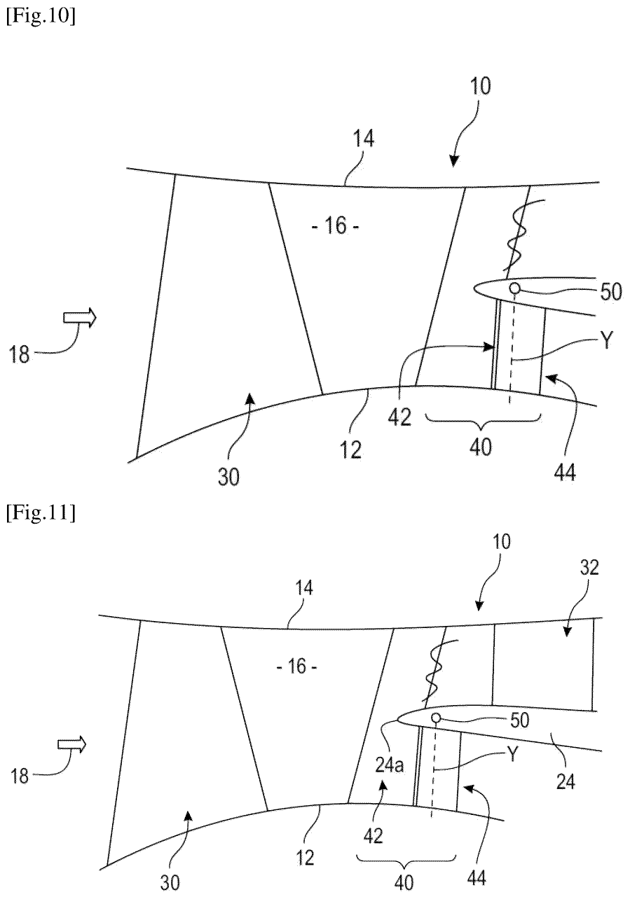

FIG. 10 illustrates an eighth embodiment of the invention which differs from the first embodiment essentially in that the stationary vanes 42 are not all identical. The stationary vanes 42 are of at least two types that differ from each other in their size and/or geometry and/or camber, etc. The different types of stationary vanes 42 are evenly distributed around the axis so as to obtain a cyclic distribution of these vanes 42 around the axis.

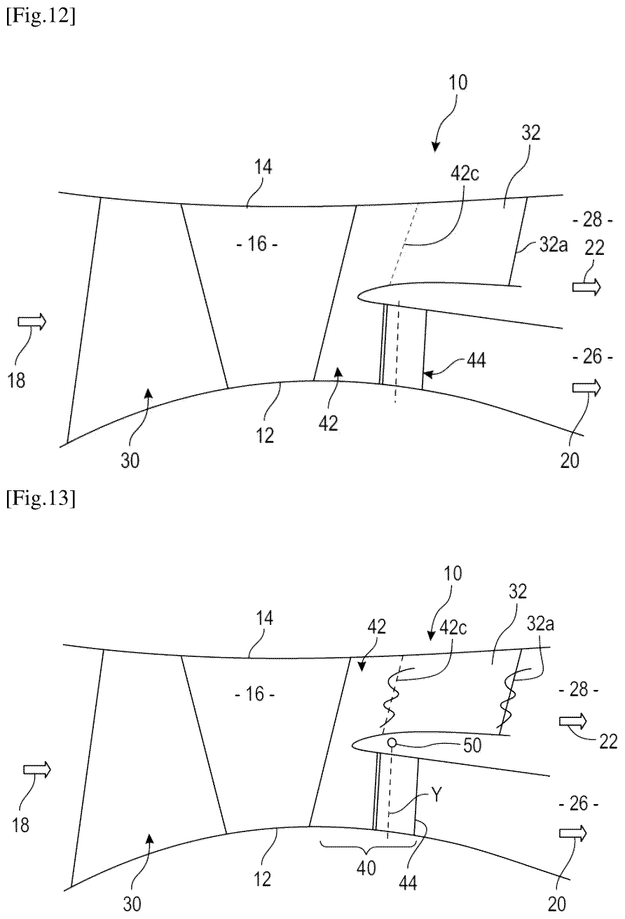

In the ninth embodiment of the invention shown in FIG. 11, structural arms 32 are located in the external duct 14 downstream of the trailing edges 42c of the stationary vanes 42. The number of arms 32 is less than the number of stationary vanes 42 and the arms 32 may extend in axial extension of some of the stationary vanes 42. The arms 32 may be all identical. In the tenth embodiment of the invention shown in FIG. 12, the structural arms 32 are moved axially upstream towards each other and are connected to certain stationary vanes 42. The arms 32 are therefore integrated with the stationary vanes 42. The stationary vanes 42 that are not connected to arms 32 have their trailing edges 42c located upstream of the trailing edges 32a of the arms.

The arms 32 are all identical in FIG. 10 and are different and cyclically distributed in the eleventh embodiment in FIG. 11. In the embodiments of FIGS. 11 to 13, some arms 32 may be solid for example and others may be tubular for the passage of auxiliaries from the external wall 14 to the separator 24.

In general, the present invention applies to any turbine engine wherein a main flow is separated into two secondary flows downstream of a ducted rotor blading.

1. A triple-flow aircraft turbine engine including a gas generator having along a longitudinal axis, at least one compressor, a combustion chamber, and at least one turbine, the turbine engine comprising:
two coaxial annular walls, respectively internal and external, extending around each other and defining therebetween a main annular duct for a main air flow;
a rotor blading extending radially across the main annular duct and forming a ducted propeller;
an annular separator disposed downstream of the rotor blading and between the two coaxial annular walls, the annular separator defining, with the internal and external coaxial annular walls, respectively, two secondary flow annular ducts, respectively internal and external, for the secondary air flow, respectively internal and external, the separator comprising at an upstream end an annular nose configured to split the main air flow into two and to form the secondary air flows;
stator elements extending radially on the one hand through the main duct and on the other hand through the secondary flow annular ducts the stator elements being connected to the annular nose; and
a non-ducted propeller disposed upstream of the external wall,
wherein the stator elements comprise:
stationary guide vanes which are distributed around the longitudinal axis and which each comprise a leading edge located upstream of the nose, and trailing edges, respectively internal and external, located respectively in the internal and external secondary ducts, these stationary guide vanes being connected to the nose;
variable-pitch guide vanes which are distributed about the longitudinal axis and which extend radially through at least one of the secondary flow annular ducts, each of the variable-pitch guide vanes comprising a leading edge and a trailing edge,
and wherein:
the leading edges of the variable pitch guide vanes are located upstream of the internal and/or external trailing edges of the stationary guide vanes; or
the leading edges of the variable pitch guide vanes are located directly downstream of the internal and/or external trailing edges of the stationary guide vanes, and are separated by predetermined axial clearances from the trailing edges.

2. The turbine engine according to claim 1, wherein the number of the variable pitch guide vanes is greater than or equal to the number of the stationary guide vanes.

3. The turbine engine according to claim 1, wherein the variable pitch guide vanes are located in the internal secondary duct.

4. The turbine engine according to claim 1, wherein the trailing edges of the variable pitch guide vanes are located downstream of the external trailing edges of the stationary guide vanes.

5. The turbine engine according to claim 4, further comprising a system for controlling the angular pitch of the variable pitch guide vanes, the system being mounted radially outwardly of the external wall.

6. The turbine engine according to claim 1, wherein the variable pitch guide vanes are located in the external secondary duct.

7. The turbine engine according to claim 1, wherein first variable pitch guide vanes are located in the internal secondary duct, and second variable pitch guide vanes are located in the external secondary duct.

8. The turbine engine according to claim 7, further comprising a common system for controlling the angular pitch of the first and second variable pitch guide vanes, or independent systems for controlling the angular pitch of the first and second variable pitch guide vanes respectively.

9. The turbine engine according to claim 1, wherein it further comprises structural arms distributed around the axis in the external secondary duct.

10. The turbine engine of claim 9, wherein the number of structural arms is less than the number of stationary guide vanes.

11. The turbine engine according to claim 9, wherein the structural arms are connected to some of the stationary guide vanes.

12. The turbine engine according to claim 1, wherein the rotor blading is a fan or a compressor rotor blading.

13. The turbine engine according to claim 1, wherein the leading edges of the variable pitch guide vanes are located at a distance from the internal and/or external trailing edges of the stationary guide vanes, and wherein the distance is greater than 10% of the chord of one of the stationary guide vanes.

14. The turbine engine according to claim 1, wherein the leading edges of the variable pitch guide vanes are located at a distance from the internal and/or external trailing edges of the stationary guide vanes, and wherein the distance is greater than or equal to 20% of the chord of one of the stationary guide vanes.
